(19) United States
(12) Patent Application Publication
(10) Pub. No.: US 2003/0093536 A1
(43) Pub. Date: May 15, 2003

(54) Support interface module

(76) Inventor: Maarten W. 't Hooft, Foster City, CA (US)

Correspondence Address: David B. Ritchie, Thelen Reid & Priest LLP, P. O. Box 640640, San Jose, CA, 95164-0640, US

(21) Appl. No.: 10/007,633

(22) Filed: Nov. 9, 2001

(51) Int. Cl. G06F 15/16; G06F 15/173

(52) U.S. Cl. 709/227; 709/223

(57) ABSTRACT

A support interface module for communications between a host system and a support host over a network. The host system includes at least one application interface having a support module. The support host includes a support services resource. The support interface module includes a session handler for receiving a user request from the support module and for controlling the activities of the support interface module, at least one session generated by the session handler for processing the user request, a transport handler initialized by the at least one session for managing communications with the support host, and at least one transport generated by the transport handler for communication of the at least one session with the support services resource. The at least one session includes an application programming interface through which the at least one session cooperates with the support module to process the user request.

### FIELD OF THE INVENTION

The present invention relates generally to user interface design enhancement. More specifically, the present invention relates to a support interface module over which channels of information can flow between an application interface and an external support service.

### BACKGROUND OF THE INVENTION

Despite the advancement of technology, users continue to experience support needs from time to time. Support may include a number of services including an explanation of features or the trouble shooting of problems. Traditional support takes many forms. For instance, support may take the form of a user manual. Many users find these little help at all if they can even locate the manual when they need one. To combat this, support may take the form of an embedded help function. This may be query or menu driven. Again this is a form of self help and it is limited to the time when the function is fixed in the application. To reduce time dependency and memory demands, support may take the form of a dedicated help server external to the application. Increasingly, applications and users are connected together by networks such as the Internet. In this case, the user leaves the application and, via the network, contacts the help server independently and seeks the support that they need there. If this does not prove adequate, the user may phone a dedicated help provider and speak with one of their representatives or listen to their automated service. Individually or in combination, traditional forms of support may often prove unsatisfactory to the user.

### BRIEF DESCRIPTION OF THE INVENTION

A support system utilizes a support interface module for communications between a host system and a support host over a network. The host system includes at least one application interface having a support module. The support host includes a support services resource. The support interface module includes a session handler for receiving a user request from the support module and for controlling the activities of the support interface module, at least one session generated by the session handler for processing the user request, a transport handler initialized by the at least one session for managing communications with the support host, and at least one transport generated by the transport handler for communication of the at least one session with the support services resource. The at least one session includes an application programming interface through which the at least one session cooperates with the support module to process the user request.

### BRIEF DESCRIPTION OF THE DRAWINGS

The accompanying drawings, which are incorporated into and constitute a part of this specification, illustrate one or more exemplary embodiments of the present invention and, together with the detailed description, serve to explain the principles and exemplary implementations of the invention.

In the drawings:

FIG. 1 is a block diagram of a support system; and

FIG. 2 is a block diagram of the support module and the support interface module of FIG. 1.

### DETAILED DESCRIPTION OF THE INVENTION

Various exemplary embodiments of the present invention are described herein in the context of a support interface module. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to exemplary implementations of the present invention as illustrated in the accompanying drawings. The same reference indicators will be used throughout the drawings and the following detailed descriptions to refer to the same or like parts.

In the interest of clarity, not all of the routine features of the exemplary implementations described herein are shown and described. It will of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

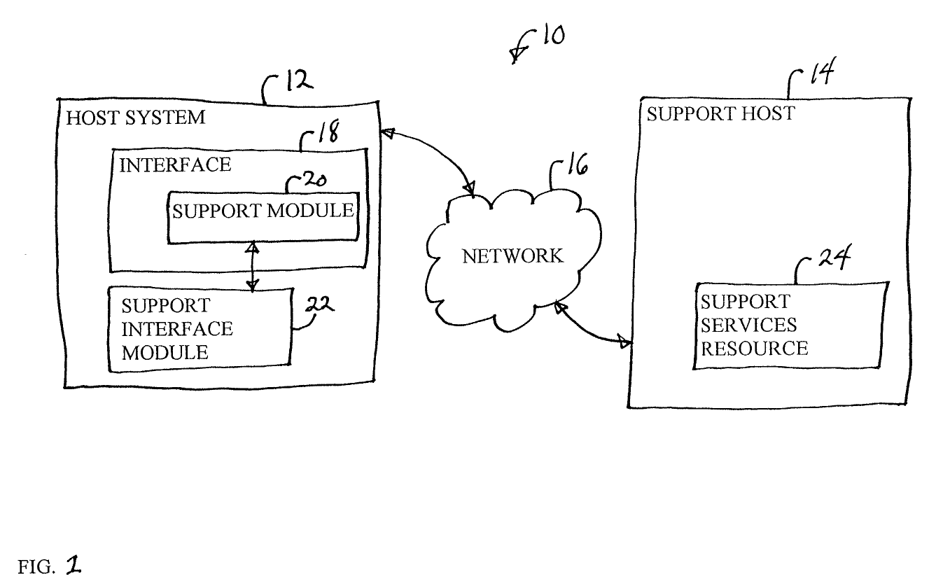

Turning first to FIG. 1, a block diagram of a support system 10 is shown. The support system 10 includes a host system 12, a support host 14, and a network 16 connecting the host system 12 to the support host 14. One of ordinary skill in the art will recognize that the network 16 may take one of many forms. For the sake of clarity, these will not be presented here. The host system 12 includes at least one application having an interface 18 for the user. The application may also take many forms including word processor or network browser. Likewise, the outward manifestation of the interface 18 may take many forms but will typically be a graphical user interface. The interface 18 includes a support module 20 that enables the user of the application to utilize various support services. These support services may include one or more of those traditional forms described above. In addition, the support module 20 communicates with and through a support interface module (SIM) 22. The SIM 22 may be integral to the application, to the host system 12, or to some combination of both. In some contexts, the SIM 22 may not be referred to as a module but will still perform the same functions. The SIM 22 provides the infrastructure over which channels of information can flow between the host system 12 and the support host 14. The support host 14 includes a support services resource 24 that is called upon to aid the user. In one valid embodiment, the SIM 22 will not be designed to be a true stand alone module and will provide an exposed Application Programming Interface (API) to which the designers of the support module 20 can write to allow their modules to access web enabled features and manage the communications for those needs. Ordinarily, the user will only view the result of the collaboration between the support module 20 and the SIM 22. The result is a support presence within the application itself.

In order for the SIM 22 to configure and manage the communication of data from the support module 20 to the support host 14, the SIM 22 will need certain pieces of information. This information includes variables such as the address of the support services resource 24, the type of communication protocol to be used, the port to contact, and the eligibility of use of the support services resource 24. The SIM 22 can obtain the necessary information in at least one of three different ways. Two of these methods rely on the use of description facilities while the third requires no description searching. First, the SIM 22 can contact a support services registry for information on a service. The location of the support services registry can be predetermined or an address for the registry can be provided by an outside source. Among other information, the registry will contain information on whether a service exists, where it is located, and who may use it. Second, the SIM 22 may contact a service description servlet at the instruction of the support module 20. The SIM 22 looks in a location specified by the support module 20 for information regarding a particular service. The service description servlet will then pass on the information in a format similar to the one found on the support services registry. Third, the SIM 22 may, on occasion, find that the support module 20 itself contains all of the information needed. If so, the SIM 22 utilizes the information provided by the support module 20 without reference to a registry or description service.

There are a number of general attributes that one might want the SIM 22 to exhibit. If one or more of these attributes are contrary to one another or to the specific environment, then they can be deleted or modified. One would prefer that the architecture of the SIM 22 be able to provide seamless communication between the user and the support services resource 24. Further one would prefer that the SIM 22 be aware of the networking environment in which it resides. This awareness might include knowing which ports are accessible, what the various latencies are, what bandwidth is available, and what the current traffic load is. Further still, one would prefer that the SIM 22 be able to ensure the security and integrity of all of its communications with the support host 14. Either continuously or on demand, one would prefer that the user be able to monitor the activity of the SIM 22. One would also prefer that the SIM 22 be able to correct for failed communication links or at least be able to present the user with options in such an event. The SIM 22 may communicate with one or more of any number of communications protocols in either or both a synchronous and an asynchronous mode.

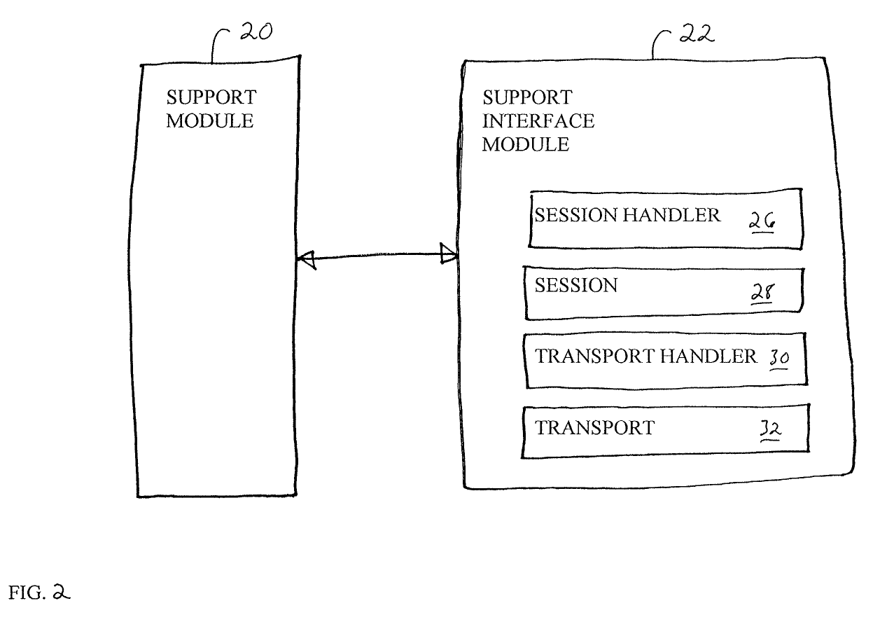

Turning now to FIG. 2, a block diagram of the support module 20 and the support interface module 22 of FIG. 1 is shown. The SIM 22 is shown to include a session handler 26, at least one session 28, a transport handler 30, and at least one transport 32 for each session 28. Each component plays a role in the process of communication between the support module 20 and the support services resource 24 of FIG. 1. Each component may be independent of one another or the SIM 22. Conversely, the function of each component may be combined in whole or in part without departing from the inventive concept disclosed herein. The session handler 26 provides coordination of the one or more sessions 28 that are ongoing. The transport handler 30 provides coordination of the one or more transports 32 per ongoing session 28.

Although each individual request for support services from a user may differ, a fairly typical support services sequence can be described. For discussion purposes, assume that a user has made a request, then the support module 20 will initially process this request. It may be the case that the support module 20 can handle the request alone. When the support module 20 can not handle all or some portion of the request alone, then it will contact the SIM 22. The SIM 22 will pass the request to the session handler 26 which will approve the request and generate at least one session 28 for the request. The session 28 will in turn initialize the transport handler 30 for the communication that will be necessary to deal with the request. The transport handler 30 will generate at least one suitable transport 32 for the session 28. The transport 32 will send data to and/or receive data from the support services resource 24 of FIG. 1. It may be the case that the transport handler 30 is instructed to redirect the communication. In such a case, the transport handler 30 may generate a new transport 32 and terminate the original transport 32. Through its API, the session 28 will cooperate with the support module 20 to satisfy the user's request. Consequently, after the initial request, all subsequent communication by the support module 20 for the request is with the session 28 and not with the session handler 26. When the request of the user is either satisfied or withdrawn, some or all of the sessions 28 and the transports 32 that were generated for that request may be terminated. Multiple requests may be processed in sequence or in parallel.

As above with the SIM 22 in general, there are a number of general attributes that one might want the components of the SIM 22 to exhibit. If one or more of these attributes are contrary to one another or to the specific environment, then they can be deleted or modified. For example, one would expect that the session handler 26 would be aware of all of the sessions 28 that are generated. Further, one would prefer that the session handler 26 hold data about the host system 12 and the network 16 of FIG. 1. Also, one would prefer that the session handler 26 be aware of the network activity originating from the host system 12. In addition, one would prefer that the session handler 26 use this network activity awareness to scale its own network activity to avoid significant performance loss to the host system 12. It would also be preferred that the session handler 26 to be able to provide information regarding or correction of communication failures. Further still, one would prefer that the session handler 26 be able to provide status info for each session 28 either continuously or on demand. It may be the case that a host system 12 includes multiple SIMs 22. In such a case, it may be necessary to coordinate the individual SIMs 22. This may be accomplished in a number of ways known to one of ordinary skill including disabling all but one of the session handlers 26 and placing the non-disabled session handler 26 in control of all of the SIMs 22. Another technique would be for the multiple session handlers 26 to hold an election to determine which session handler 26 will control the multiple SIMs 22.

With respect to the sessions 28, although there may be multiple sessions 28 running in series or in parallel, the individual sessions 28 may not be aware of one another. Further, one would prefer that the sessions 28 have a finite length and that either or both the session handler 26 and the support module 20 be able to terminate the session 28. One would prefer for the session 28 to control communications between the SIM 22 and the support module 20.

With respect to the transport handler 30, one would expect that the transport handler 30 would be aware of all of the transports 32 that it has generated. If there are multiple SIMs 22, a first transport handler 30 may or may not be aware of a second transport handler 30 or the transports 32 that the second transport handler 30 has generated. Further, one would expect the transport handler 30 to be able to communicate using one or more of any number of protocols. One would prefer that the transport handler 30 be able to generate diagnostic information on the network environment and characteristics and be able to pass this information on to the session handler 26. One would also prefer that the transport handler 30 be able to report errors and exceptions to the session handler 26.

With respect to the transports 32, although there may be multiple transports 32 in series or in parallel, the individual transports 32 may not be aware of one another. It may be the case that the transport 32 is channel dependent such that when the channel fails the transport 32 ends and a new transport 32 may have to be generated by the transport handler 30 to complete the failed communication.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A support interface module for communications between a host system and a support host over a network, the host system includes at least one application interface having a support module, the support host includes a support services resource, the support interface module comprising:
a session handler for receiving a user request from the support module and for controlling the activities of the support interface module;
at least one session generated by the session handler for processing the user request;
a transport handler initialized by the at least one session for managing communications with the support host; and
at least one transport generated by the transport handler for communication of the at least one session with the support services resource.

2. The support interface module as defined in claim 1, wherein the at least one session comprises an application programming interface through which the at least one session cooperates with the support module to process the user request.

3. A host system connected by a network to a support host having a support services resource, the host system comprising:
at least one application having a support module for receiving a user request; and
a first support interface module comprising:
a session handler for receiving the user request from the support module and for controlling the activities of the first support interface module;
at least a first session generated by the session handler for processing the user request;
a first transport handler initialized by the at least a first session for managing communications with the support host; and
at least a first transport generated by the first transport handler for communication of the at least a first session with the support services resource.

4. The host system as defined in claim 3, wherein the at least a first session comprises an application programming interface through which the at least a first session cooperates with the support module to process the user request.

5. The host system as defined in claim 3, further comprising a second support interface module comprising:
at least a second session generated by the session handler for processing a user request;
a second transport handler initialized by the at least a second session for managing communications with the support host; and
at least a second transport generated by the second transport handler for communication of the at least a second session with the support services resource.

6. The host system as defined in claim 5, wherein the at least a second session comprises an application programming interface through which the at least a second session cooperates with the support module to process the user request.

7. A method of service request communication between a support module and a support interface module, the method comprising:
receiving a service request by the support interface module from the support module;
establishing overall control of the service request process;
generating at least one session for the service request;
initializing communication control of the service request process;
generating at least one transport for the at least one session; and
transmitting and/or receiving data via the at least one transport.

8. The method as defined in claim 7, further comprising terminating the at least one session when the service request is either satisfied or withdrawn.

9. The method as defined in claim 7, further comprising terminating the at least one transport for the at least one session when the service request is either satisfied or withdrawn.

10. A support interface module for communications between a host system and a support host over a network, the host system includes at least one application interface having a support module, the support host includes a support services resource, the support interface module comprising:
means for receiving a service request from the support module;
means for establishing overall control of the service request process;
means for generating at least one session for the service request;
means for initializing communication control of the service request process;
means for generating at least one transport for the at least one session; and
means for transmitting and/or receiving data via the at least one transport.

11. The support interface module as defined in claim 10, further comprising means for terminating the at least one session when the service request is either satisfied or withdrawn.

12. The support interface module as defined in claim 10, further comprising means for terminating the at least one transport for the at least one session when the service request is either satisfied or withdrawn.
